(19) United States
(12) Patent Application Publication
(10) Pub. No.: US 2013/0324116 A1
(43) Pub. Date: Dec. 5, 2013

(54) VIRTUAL HOME NETWORK

(71) Applicant: TELEFONAKTIEBOLAGET L M ERICSSON (PUBL), Stockholm (SE)

(72) Inventors: Hakan Andersson, Vaxholm (SE); Krister Svanbro, Sollentuna (SE); Erik Westerberg, Enskede (SE); Goran Rune, Linkoping (SE); Magnus Olsson, Stockholm (SE); Lennart Norell, Alvsjo (SE)

(73) Assignee: TELEFONAKTIEBOLAGET L M ERICSSON (PUBL), Stockholm (SE)

(21) Appl. No.: 13/901,247

(22) Filed: May 23, 2013

Related U.S. Application Data
(60) Provisional application No. 61/651,358, filed on May 24, 2012.

(51) Int. Cl. H04W 8/06

(52) U.S. Cl. CPC H04W 8/06
USPC 455/433

(57) ABSTRACT

There is disclosed a network node acting as a virtual home network. The network node comprises a communications interface arranged to receive a service request for a service from a user equipment in a visited network, the user equipment being associated with a home network operator and the service being associated with actions. The communications interface is further arranged to receive a service control and policy environment of the home network operator, the communications interface thereby being arranged to acquire control of said actions. The network node further comprises a processing unit arranged to, based on the actions, determine a service access route for the user equipment to access the service.

### CROSS-REFERENCE TO RELATED APPLICATIONS

This application claims the priority benefit under 35 U.S.C. §119(e) of U.S. Provisional Application No. 61/851,358 filed on May 24, 2012, the disclosure of which is incorporated herein by reference in its entirety.

### TECHNICAL FIELD

Embodiments presented herein relate to a network node in a communications network, and particularly to a network node acting as a virtual home network. Corresponding methods, computer programs and computer program products are also disclosed.

### BACKGROUND

With the introduction of GSM (global system for mobile communications) also came the introduction of roaming on a broader scale. Roaming enables a user to bring and use his UE (user equipment, such as a mobile communications terminal) while travelling to areas served by other operators than his home network operator, and still be reached on the same telephone number as in his home network.

in GSM the basic services were well specified and homogeneously implemented, so that when a subscriber was roaming, the services were executed in the visited network. E.g. when making a voice call in a visited network, it was the MSC (mobile switching center) In the visited network that handled the call, and routed it to the receiving party. In general terms, the MSC is the primary service delivery node for GSM/CDMA (code division multiple access), responsible for routing voice calls and SMS (short message service) as welt as other services (such as conference calls and circuit switched data). The visited MSC (V-MSC) is the MSC where the UE is currently located. Advanced services though (e.g. IN (Intelligent network) based short number dialling), did not initially function whilst roaming. Support for this was later introduced by CAMEL (Customised Applications for Mobile networks Enhanced Logic, ETSI TS 123 078), which still was not mandatory for operators to implement).

With the introduction of IP (Internet protocol) based services (e.g. using GPRS (General packet radio service), HSPA (High Speed Packet Access), LTE (Long Term Evolution) etc.), the set of services were less well defined. Thus, for the IP traffic, the traffic from a roaming subscriber is routed from the visited operator in the visited network to the home network operator in the home network and access to Internet, as well as execution of services, are performed at the home network.

### SUMMARY

An object of embodiments herein is to provide an improved experience for the subscriber, and also reduce the data capacity need between different operators for roaming subscribers. The inventors of the enclosed embodiments have through a combination of practical experimentation and theoretical derivation discovered that part of the traffic routed via the home network advantageously could be routed directly to the service requested by the subscriber. A particular object is therefore to enable for an operator the possibility to break out traffic to, e.g., the internet, closer to the location of the subscriber (i.e. closer in geographical sense to the location of the UE).

According to a first aspect there is presented a network node acting as a virtual home network. The network node comprises a communications interlace arranged to receive a service request for a service from a user equipment in a visited network, the user equipment being associated with a home network operator and the service being associated with actions. The communications interface is further arranged to receive a service control and policy environment of the home network operator, the communications interface thereby being arranged to acquire control of the actions. The network node comprises a processing unit arranged to, based on the actions, determine a service access route for the user equipment to access the service.

Thereby, by means of the disclosed network node, a new role, a point of presence (Pop) provider is established in the network topology. A party may establish such PoPs on a number of locations in different networks, from where the disclosed network node is enabled to interconnect to operators located in the same region as where the network node is established (or regions located nearby) and also interconnect to, e.g., the Internet.

Advantageously the disclosed network node will also overcome the “tromboning” effects seen for some operator offered services (as in FIGS. 1 and 2).

The network node may act as a virtual home network towards one or more visited networks catering for roaming subscribers.

The actions may relate to a gateway functionality controlled by the service control and policy environment.

The gateway functionality may allow the user equipment access to Internet directly via the network node.

The communications interface may further be arranged to, from the home network operator, receive control information relating to the service access route for a service related to charging, local IP address, and/or a policy control service, the home network operator thereby controlling the service.

The communications interface may further be arranged to prevent an operator of said network node to control and/or access information of the user equipment relating to the service access route for a service related to charging, local IP address, and/or a policy control service.

The communications interface may further be arranged to, from the home network operator, receive control information relating to the service access route for a service related to home subscriber server, HSS, policy databases, and/or at least a part of a policy control, the home network operator thereby controlling the service.

The communications interface may further be arranged to prevent an operator of said network node to control and/or access information of said user equipment relating to said service access route for a service related to home subscriber server, HSS, policy databases, and/or at least a part of a policy control.

The pail of the policy control may relate to a home policy charging rules functionality, h-PCRF.

The at least a part of the policy control may include an entirety of the policy control.

The actions may further be based on policies and subscribed services for a roaming subscriber of the user equipment.

The communications interface may further be arranged to, from a gateway through which the user equipment is arranged to access Internet or from another network node executing the service, acquire data relating to at least one of: a call detail record, data volumes consumed by the user equipment, and calls made from the user equipment; and the communications interface may further be arranged to transmit the acquired data to the home network operator.

The communications interface may further be arranged to, from the home network operator, receive a management request, the management request relating to management of specified functionality of the home network operator; and the processing unit may further be arranged to, in response to the management request, manage the specified functionality of the home network operator.

The communications interface may further be arranged to, with the home network operator, exchange data to confirm that the network node manages connections and services of the user equipment according to the service control and policy environment of the home network operator.

The communications interface may further be arranged to provide the home network operator with data related to services used and/or invoked by the user equipment.

The service may be Internet protocol based multimedia service, IMS, voice over internet protocol, VoIP, call.

The network node may further comprise a memory arranged to store or mirror select home network content.

The memory may further be arranged to store a charging environment of file home network.

The processing unit may further be arranged to perform control and management of access to content, said content including content directly accessible via said network node for the user equipment from a service, content in the memory of the network node, content at the content storage of the home network operator, and/or content accessible via the point of interface, Pol, of the home network operator.

The processing unit may further be arranged to execute selected services, such as voice call handling, of the user equipment.

The processing unit may further be arranged to control and/or handle adult content filtering in the user equipment.

The processing unit may further be arranged to perform deep packet inspection, DPI, and/or anti-virus protection on behalf of the home network.

The processing unit may further be arranged to handle traffic and transport optimizing, such as compression, transport control protocol, TCP, optimization and/or other protocol optimization.

The processing unit may further be arranged to provide multi access control from the network node on behalf of the home network operator, such as control of roaming to WiFi access points available at a visited location.

The processing unit may further be arranged to monitor subscriber service quality, such as data rates of Internet access of the user equipment.

According to a second aspect there is presented a method performed by a network node for the network node to act as a virtual home network. The method comprises receiving, by a communications interface, a service request for a service from a user equipment in a visited network, the user equipment being associated with a home network operator and the service being associated with actions. The method comprises receiving, by the communications interface, a service control and policy environment of the home network operator the communications interface thereby acquiring control of the actions. The method comprises determining, by a processing unit, a service access route for the user equipment to access the service based on the actions.

According to a third aspect there is presented one or more computer readable media comprising computer program code for causing a network node to act as a virtual home network, wherein the computer program code, when run on one or more processing units of said network node, causes the network node to perform a method according to the second aspect.

It is to be noted that any feature of the first, second, and third aspects may be applied to any other aspect, wherever appropriate. Likewise, any advantage of the first aspect may equally apply to the second, and/or third aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning In the technical field, unless explicitly defined otherwise herein. All references to “a/an/the/said element, apparatus, component, means, step, etc,” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the invention will now be described, by way of non-limiting examples, references being made to the accompanying drawings, in which.

FIG. 1 is a schematic diagram illustrating a prior art communications network;

FIG. 2 is a schematic diagram showing functional modules of a network node:

FIGS. 3-5 are schematic diagrams illustrating communications networks according to embodiments;

FIG. 8 is a flowchart of a method according to embodiments; and FIG. 7 shows one example of a computer program product comprising computer readable means.

### DETAILED DESCRIPTION

The invention will now be described more fully hereinafter with reference to the accompanying drawings, m which certain embodiments of the invention are shown, This invention may, however, be embodied In many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

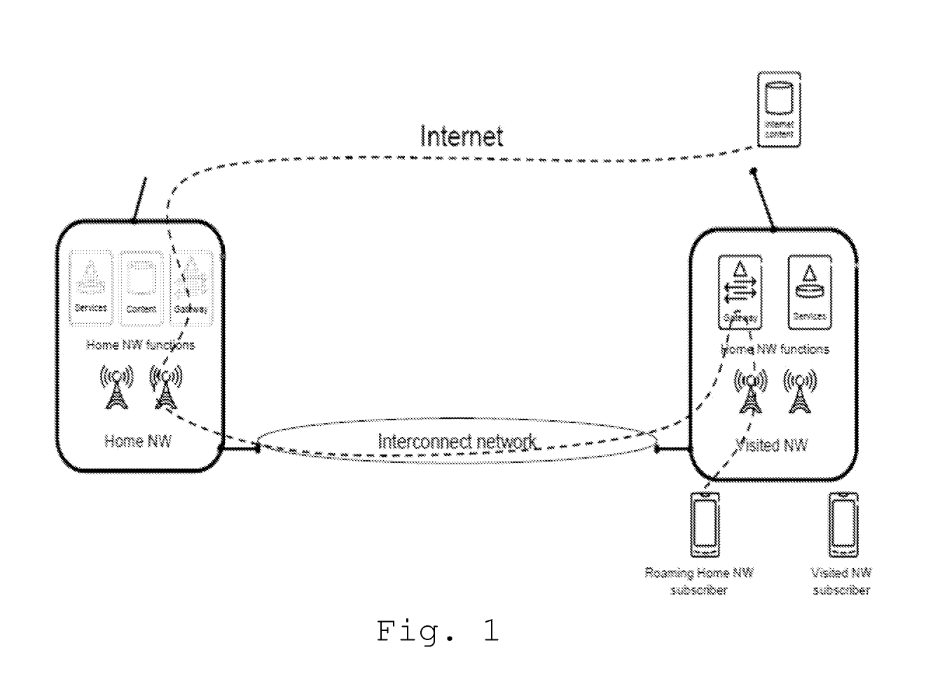

For a Swedish subscriber visiting the USA, signals for basic access to Internet servers (e.g. web pages) are today routed from the roaming subscriber in the USA to the home network in Sweden before accessing the Internet. This process is schematically illustrated in FIG. 1. FIG. 1 illustrates a communications network 1 comprising a home network (NW) and a visited NW. The home NW and the visited NW provides services, content and gateway functionality to devices operatively connected thereto. A roaming home subscriber operatively connected to the visited NW is re-routed through an interconnect network to the home NW and then to Internet in order to retrieve Internet content.

Today roaming thus means that ail traffic and content must re routed to the home network before it is routed to the Internet. This implies higher cost and low performance. In order to avoid these effects, 3GPP has specified solutions for “local break-out”. For local breakout the end-customer (i.e. the user of the UE) loses ail services tied to his local IP address or subscription, if the end user at the UE turns off roaming and instead use public WiFi the operator loses the customer. For improved local breakout, the inventors of the enclosed embodiments have realized that the visited networks have to be upgraded (which is out of the control of the home network operators), services harmonized (also out of control of the home network operator), and roaming agreements updated. Also there needs to be a strong trust between the operators.

The disclosed embodiments are, in contrast, based on the understanding that the end user should be enabled to make use of all his services connected to his IP address and subscription, also when roaming these capabilities should be enabled on behalf of the home network operator. He should be able to keep all his services related to charging, his local IP address, his policy control services, etc. Further, this should be accomplished with better performance and more cost-efficiency. The disclosed embodiments are based on the understanding of handling and fuming traffic regionally.

As will be further disclosed below, the data service is hosted in a network node, a so called point of presence provider, on behalf of the home network operator and thereby the data service is handled regionally. The local operator is thereby given a global presence. Thereby the international roamer is enabled to keep the services provided by the home network operator.

MBB (mobile broadband) functionality may be included by a regionally PoP provider and run as a service for any operator or operators.

FIG. 6 is a flow chart illustrating embodiments of a method for a network node to act as a virtual home network. The herein disclosed methods are preferably performed in the network node 2.

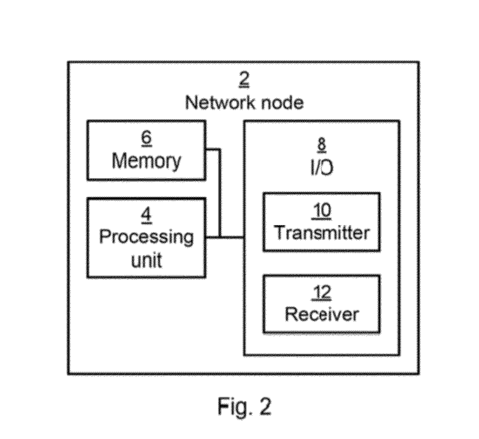

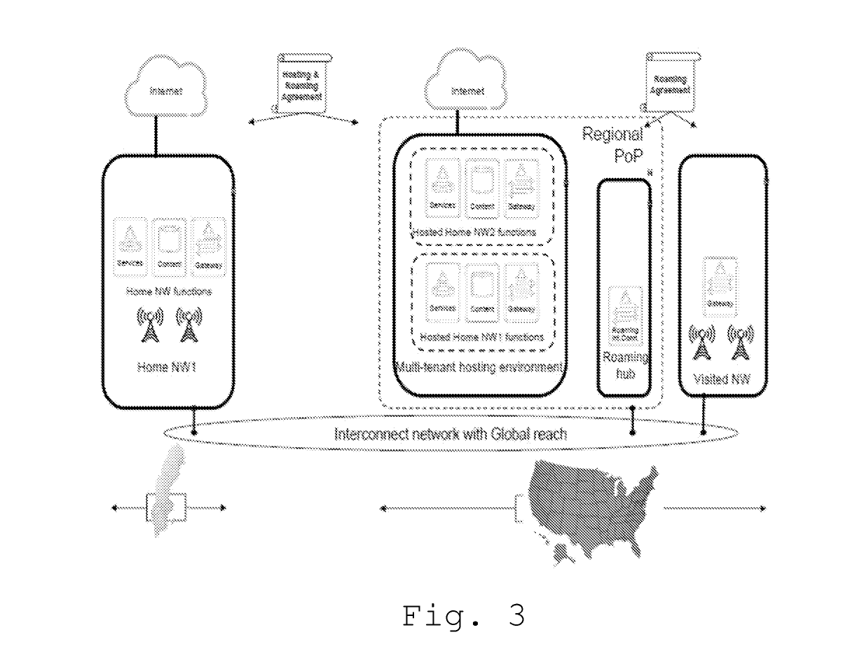

FIG. 2 schematically illustrates, in terms of a number of functional modules, the components of a network node 2. The network node acts as a virtual home network. In general the network node acts as a virtual home network towards one or more roaming visited networks. A processing unit 4 is provided using any combination of one or more of a suitable central processing unit (CPU), multiprocessor, microcontroller, digital signal processor (DSP), application specific integrated circuit (ASIC) etc., capable of executing software instructions stored in a computer program product 22 (as in FIG. 7), e.g. in the form of a memory 6. Thus the processing unit 4 is thereby preferably arranged to execute methods as herein disclosed. The memory 8 may also comprise persistent storage, which, for example, can be any single one or combination of magnetic memory, optical memory, solid state memory or even remotely mounted memory.

The network node 2 may further comprise an input/output (I/O) communications interface 8 for communicating with a home network and one or more visited networks over an interconnect network and optionally with other network nodes. The input/output (I/O) communications interface 8 may further comprise one or more dedicated transmitters 10 and receivers 12, comprising analogue and digital components forming the functionalities of a transmitter and a receiver. The processing unit 4 controls the general operation of the network node 2, e.g. by sending control signals to the transmitter 10 and/or receiver 12 of the input/output (I/O) communications interface 8 and receiving reports from the transmitter 10 and/or receiver 12 of its operation.

The disclosed network node may be regarded as a point of presence (PoP) provider and the disclosed network node will therefore in the following also be denoted a PoP node (provided by a PoP provider). Such a PoP node is advantageously placed at different locations. In general the functionality of the disclosed network node 2 (or PoP node) may be distributed in a set of different network nodes. A PoP site may thus be regarded as a site on which a set of such network nodes are placed.

The communications interface of the network node is arranged to, in a step S2, receive a service request for a service from a user equipment in a visited network, the user equipment being associated with a home network operator and the service being associated with actions.

At those locations, the PoP provider/node thereby offer mobile operators the functionality required to break out traffic that will benefit from being routed from this location directly, instead of going back through the home network (as in FIG. 1). Thus, the actions may relate to a gateway functionality controlled by the service control and policy environment.

This functionality could include (but is not limited to), gateway functionality that is controlled by policies and services of the mobile operator to allow for access to Internet closer to the roaming subscriber, rather than via the home network operator. Thus the gateway functionality may allow the user equipment access to internet directly via the disclosed network node.

Other examples of functionality that may be offered is the possibility for the home network operator to store or mirror selected content at the offered PoP provider, in order to make this more readily available to the roaming subscribers.

There are other functionalities that may be handled at the premises of the PoP node. Some of these functionalities are listed next. The PoP provider/node may keep a replication of the charging environment of the home network. The PoP provider/node may handle control and management of access to content, e.g. what data to provide via local interconnection, or what content to cache at the PoP provider/node, and what content to access at the home network operator's content storage. Execution of selected services may be performed at the local Pop provider/node, e.g. basic voice call handling. There may also be adult content filtering and mechanisms to control and manage this in the PoP provider/node. DPI (deep packet inspection) and anti-virus protection on behalf of the home network may be performed in the PoP provider/node. Traffic and transport optimizing (compression, TCP optimization and other protocol optimization to improve service and reduce cost) may be handled by the PoP provider/node. The Pop provider/node may handle multi access control provider on behalf of the home network, e.g. control of roaming to WiFi access points available in the region of the PoP provider/node. The PoP provider/node may handle subscriber service quality monitoring, e.g. data rates of the internet access.

All these services may thus be offered to the home network operator without any impact on the visited networks, thus taking away the need for network upgrades at the visited network, or changes in roaming agreements etc.

Some other services could also be offered, which would benefit from some additions to the agreement with the visited operators, e.g. providing services with different QoS (quality of service). Through means of the PoP provider/node/node, these agreements can be made by the PoP provider/node on behalf of all operators which if offers its services to. This will take away the need for a multiple bi-lateral agreements (i.e. many-to-many agreements). An example of an additional service that can be offered in this case is content acceleration over the mobile access in the roaming network. Based on the augmentation of the agreements, other services can also be provided, such as priority access for high paying subscribers.

According to embodiments the PoP provider/node also provides roaming services. This enables a “one-stop-shop” service to be offered whereby the PoP provider/node allows for both global roaming, as well as local PoP by only establishing an agreement with the PoP provider/node.

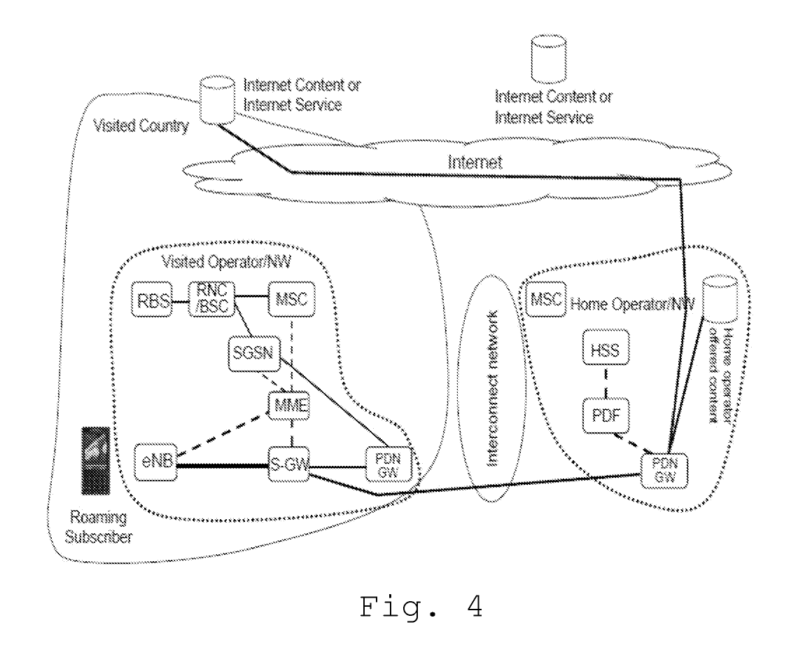

FIG. 3 gives a high level example of an implementation of a PoP site of a PoP provider. In the example of FIG. 3 it is shown how two different home network operators, denoted home NW 1 and home NW 2, are subscribing to gateway, content caching and selected services to be based in the region served by the PoP provider/node. In general, regional PoPs may be located in a number of regions and are preferably connected with high data rates. The regional PoP acts as a virtual home network towards the roaming target networks in the region according to hosting and roaming agreements. As noted above, the (regional hub of the) regional PoP provider/node acts as an extended site on behalf of the home network.

An alternative solution is for an operator itself that wishes to provide break-out as well as other services that are beneficial to locate close to the roaming subscriber, to establish the local presence himself at selected locations by means of the disclosed PoP provider/node. Preferably the PoP provider/node is in such cases arranged for single tenant hosting (i.e. for only one operator).

As noted above PoP provider/nodes are provided at selected locations in different networks of different operators. The disclosed network node provides the equipment required to offer the service. Also a point of interface, Pol, may be established. In addition PoP provider/nodes may be provided at additional locations and connected to a main hub in the region in order to easier connect to operators in the region. Between the locations the PoP provider/node establishes connectivity, either through the home network, or through leased connectivity. Connectivity through the Internet is one option.

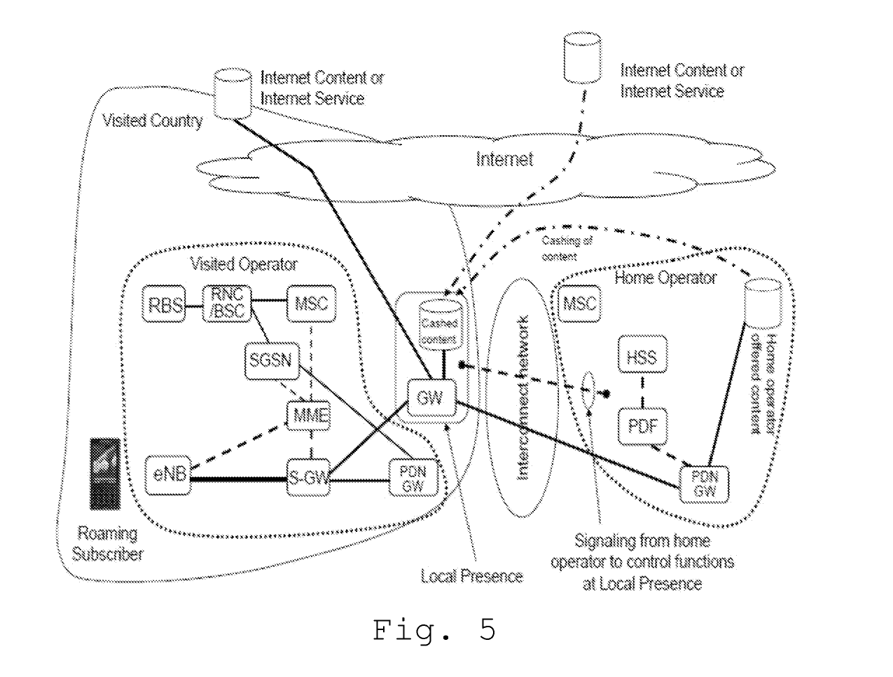

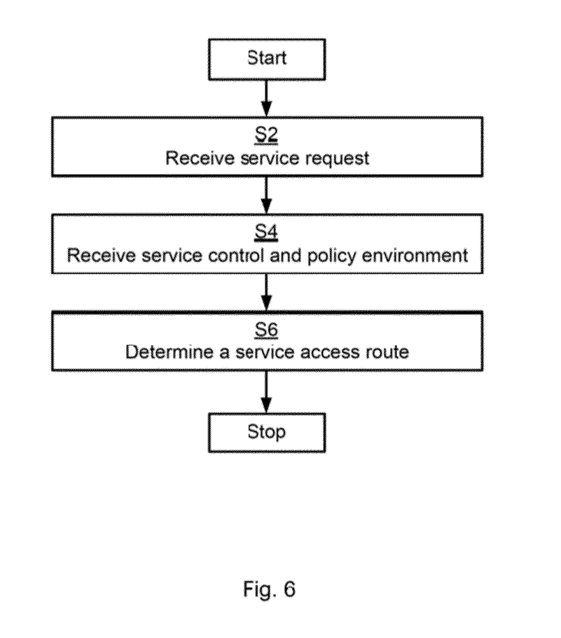

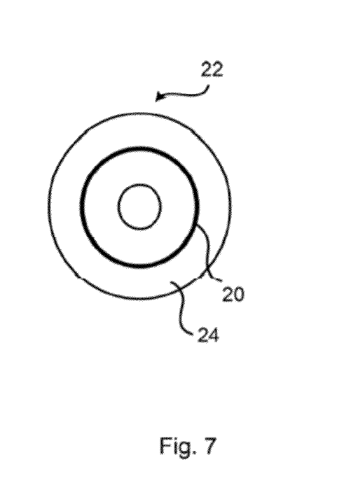

More detailed examples of different implementations are shown in FIGS. 4 and 5.

In the examples illustrated in FIGS. 4 and 5 the wireless communication systems for illustrational purposes comprise a first base station in the form of an eNodeB (eNB), operatively connected to a Serving Gateway (S-GW), in turn operatively connected to a Mobility Management Entity (MME) and a PDN Gateway (PGW). For illustrational purposes the wireless communication systems further comprise a second base station in the form of a radio base station (RBS) which may be a NodeB or a Base Transceiver Station (BTS).

The eNodeB is a radio access node that interfaces with a radio terminal, which is denoted User Equipment (UE) in LTE. The eNodeBs of the system forms the radio access network E-UTRAN for LTE. The S-GW routes and forwards user data packets, whilst also acting as the mobility anchor for the user plane during inter-eNB handovers and as the anchor for mobility between LTE and other 3GPP technologies (terminating S4 interface and relaying the traffic between 2G/3G systems and PDN GW). For idle state UEs, the SGW terminates the downlink (DL) data path and triggers paging when DL data arrives for the user equipment (UE). It manages and stores UE contexts, e.g. parameters of the IP bearer service, network internal routing information, it also performs replication of the user traffic in case of lawful interception.

The MME is responsible for idle mode UE tracking and paging procedure Including retransmissions. It is involved in the bearer activation/deactivation process and is also responsible for choosing the S-GW for a UE at the initial attach and at time of intra-LTE handover involving Core Network (CM) node relocation, it is responsible for authenticating the user (by interacting with the HSS). The Non-Access Stratum (NAS) signaling terminates at the MME and it is also responsible for generation and allocation of temporary identifies to UEs. It checks the authorization of the UE to camp on the service provider's Public Land Mobile Network (PLMN) and enforces UE roaming restrictions. The MME is the termination point in the network for ciphering/integrity protection for NAS signaling and handles the security key management. Lawful interception of signaling is also supported by the MME. The MME also provides the control plane function for mobility between LTE and 2G/3G access networks with the S3 interface terminating at the MME from the SGSN. The MME also terminates the S6a interface towards the home HSS for roaming UEs. The UE-related control signaling is handled by the Serving GPRS Support Node (SGSN) with support of subscription information provided by the Home Subscriber Server (HSS).

The wireless network may comprise groups of UEs communicating with one or more eNodeBs, which communicate with one or more Serving Gateways (S-GWs), which communicate with a Packet Data Network (PDN) Gateway (PDN-GW), which communicates with fixed networks such as IP Multimedia Subsystem (SMS) access networks or core networks. The PDN GW provides connectivity to the UE to external packet data networks by being the point of exit and entry of traffic for the UE. A UE may have simultaneous connectivity with more than one PGW for accessing multiple PDNs. The PDN GW performs policy enforcement, packet filtering for each user, charging support, lawful interception and packet screening. Another key role of the PGW is to act as the anchor for mobility between 3GPP and non-3GPP technologies such as WiMAX and 3GPP2 (CDMA 1X and EvDO).

The wireless communication system may further comprise a Gateway GPRS Support Node (GGSN) connected to a Serving GPRS Support Node (SGSN). In turn, the SGSN is connected to a Radio Network Controller (RNC) that is operatively connected to a radio base station (RBS) in the form of a NodeB, or to a Base Station Controller (BSC) that is connected to a radio base station (RBS) in the form of a Base Transceiver Station (BTS).

The GGSN is responsible for the interworking between the GPRS network and external packet data networks, like the Internet and X.25 networks. The GGSN is the anchor point that enables the mobility of the UE in the GPRS/UMTS networks and it may be seen as the GPRS equivalent to the Home Agent in Mobile IP. It maintains routing necessary to tunnel the Protocol Data Units (PDUs) to the SGSN that services a particular Mobile Station (MS). The GGSN converts the GPRS packets coming from the SGSN into the appropriate packet data protocol (PDP) format (e.g., IP or X.25) and sends them out on the corresponding packet data network. In the other direction, PDP addresses of incoming data packets are converted to the GSM address of the destination user. The readdressed packets are sent to the responsible SGSN. The GGSN is responsible for IP address assignment and is the default router for the connected UE. The GGSN also performs authentication and charging functions. Other functions include subscriber screening, IP Pool management and address mapping, QoS and PDP context enforcement.

The SGSN is responsible for the delivery of data packets from and to UEs within its geographical service area. Its tasks include packet routing and transfer, mobility management (attach/detach and location management), logical link management, and authentication and charging functions. The location register of the SGSN stores location information (e.g., current cell, current Visitor Location Register (VLR)) and user profiles (e.g., International Mobile Station Identify (IMSI), address(es) used in the packet data network) of all GPRS users registered with this SGSN.

The RNC is a node in the UMTS radio access network (UTRAN) and is responsible for controlling the NodeBs that are operatively connected to it. The RNC carries out radio resource management, some of the mobility management functions and is the point where encryption is done before user data is sent to and from the mobile. The RNC is operatively connected to a Circuit Switched Core Network through Media Gateway (MGW) and to the SGSN in the Packet Switched Core Network.

The BSC is a node in the GSM Radio Access Network (GERAN) and is responsible for controlling the BTSs that are connected to it. The BSC carries out radio resource management and some of the mobility management functions.

As can be seen in FIGS. 4 and 5, there is a UE exemplified by a roaming subscriber that communicates with the eNodeB and/or the RNC via a NodeB and/or the BSC via a BTS using an air interface such as LTE-Uu, Um and Gb interface respectively. This makes it possible for the UE to access resources provided by the core network of the systems, respectively. A skilled person having the benefit of this disclosure realizes that a vast number of well known UEs can be used in the various embodiments of the present disclosure. The UE may e.g. be a cell phone device or similar, e.g. such as a Mobile Station (MS) or similar, e.g. defined by the standards provided by the 3GPP. Thus, the UE needs no detailed description as such. However, it should be emphasized that the UE may be embedded (e.g. as a card or a circuit arrangement or similar) in and/or attached to various other devices, e.g. such as various laptop computers or tablets or similar or other mobile consumer electronics or similar, or vehicles or boats or air planes or other movable devices, e.g. intended for transport purposes. Indeed, the UE may even be embedded in and/or attached to various semi-stationary devices, e.g. domestic appliances or similar, or consumer electronics such as printers or similar having a semi-stationary mobility character.

In the examples illustrated in FIGS. 4 and 5 of a PoP provider/node site, there are gateways (GW), transcoding functionality, content storage and services. Some or all of these could be single tenant, on dedicated servers, or multi tenant. They could also be provided on a virtualized and/or cloud environment. The Pop provider/node Is arranged to manage the environment in line with Service Level Agreements towards the served operators. As noted above, the actions of the offered functions are controlled via a communications interface to provide the service control and policy environment of the home network operator.

The communications interface of the network node is arranged to, in a step S4, receive a service control and policy environment of the home network operator, communications interface thereby being arranged to acquire control of the actions.

The processing unit of the network node is arranged to, in a step S6, based on the actions, determine a service access route for the user equipment to access the service.

According to an embodiment the service control is part of the offered services. The ordered actions may be based on policies and subscribed services for the roaming subscriber. Call detail records (CDRs), information of data volumes consumed by the subscriber, calls made by the subscriber, etc, are preferably collected and sent back to the home network operator for charging and other purposes.

If requested by the home network operator, the PoP provider/node according to embodiments also offers management interlaces to allow for the home network operator to manage functionalities of the home network operator at the PoP provider/node site as being an integral part of the home network operators own network and services.

Examples of functionality still residing at the home network operator preferably includes HSS (home subscriber server), policy data bases, policy control (either the complete policy control, or a part of it, e.g. home policy charging rules functionality, h-PCRF) which may be too sensitive to open up for access by a third party (such as an operator of the PoP node). According to embodiments the network node 2 is therefore prevented from controlling and/or even accessing such information. According to embodiments the network node 2 may receive control information relating to these services from the home network operator. In such cases the control information is therefore preferably encrypted.

Between the home network and the local PoP node offered by the PoP provider, there will be signalling and mechanisms to ensure that the functionality and nodes at the local PoP manages the connections and services of the roaming subscriber in line with the intention of the home network operator. This signalling may be based on 3GPP (3rd Generation Partnership Project) interfaces, but could be augmented with additional functions necessary to allow for control of the functions subscribed by the home network operator, whilst still protecting sensitive data.

According to embodiments there could also be signalling and mechanisms to provide information back to the home network operator related to the services of the roaming subscriber. In this way the home network operator may e.g. monitor quality and activities, but also adjust the services and functions of the roaming subscriber.

In addition to functionality to handle the routing and selected services on behalf of the home network operators, the PoP site is according to embodiments also enabled to offer hosted services such as HQ visualcom, or other advanced services for which operators might hesitate to fake required capital expenditure upfront.

The herein disclosed methods are advantageously provided as computer programs 20. FIG. 7 shows one example of a computer program product 22 comprising an example computer readable medium 24. On this computer readable medium 24, computer program code 20 can be stored, which computer program code 20 can cause the processing unit 8 and thereto operatively coupled entities and devices, such as the memory 6, the I/O communications interface 8, the transmitter 10, and/or the receiver 12 to execute methods according to embodiments described herein. In the example of FIG. 5, the computer program product 22 is illustrated as an optical disc, such as a CD (compact disc) or a DVD (digital versatile disc) or a Blu-Ray disc. The computer program product could also be embodied as a non-transitory memory (e.g., RAW, ROM, EPROM, EEPROM) and more particularly as a non-volatile storage medium of a device in an external memory such as a USB (Universal Serial Bus) memory, or as a transitory signal downloadable via a network connection. Thus, while the computer program 20 is here schematically shown as a track on the depicted optical disk, the computer program 20 can be stored in any way which is suitable for the computer program product 22.

The invention has mainly been described above with reference to a few embodiments, However, as is readily appreciated by a person skilled in the art, other embodiments than the ones disclosed above are equally possible within the scope of the invention, as defined by the appended patent claims.

1. A network node acting as a virtual horns network, comprising
a communications interface arranged to receive a service request for a service from a user equipment in a visited network, the user equipment being associated with a home network operator and the service being associated with actions;
said communications interface further being arranged to receive a service control and policy environment of said home network operator, said communications interface thereby being arranged to acquire control of said actions; and
a processing unit arranged to, based on said actions, determine a service access route for said user equipment to access said service.

2. The network node according to claim 1, wherein said network node acts as a virtual home network towards one or more visited networks catering for roaming subscribers.

3. The network node according to claim 1, wherein said actions relate to a gateway functionality controlled by said service control and policy environment.

4. The network node according to claim 3, wherein said gateway functionality allows said user equipment access to internet directly via said network node.

5. The network node according to claim 1, wherein
said communications interface further is arranged to, from said home network operator, receive control information relating to said service access routs for a service related to charging, local IP address, and/or a policy control service, the home network operator thereby controlling the service.

6. The network node according to claim 1, wherein
said communications interface further is arranged to prevent an operator of said network node to control and/or access information of said user equipment relating to said service access route for a service related to charging, local IP address, and/or a policy control service.

7. The network node according to claim 1, wherein
said communications Interface further is arranged to, from said home network operator, receive control information relating to said service access route for a service related to home subscriber server, HSS, policy databases, and/or at least a part of a policy control, the home network operator thereby controlling the service.

8. The network node according to claim 1, wherein
said communications interface further is arranged to prevent an operator of said network node to control and/or access information of said user equipment relating to said service access route for a service related to home subscriber server, HSS, policy databases, and/or at least a part of a policy control.

9. The network node according to claim 7, wherein said part of said policy control relates to a home policy charging rules functionality, h-PCRF.

10. The network node according to claim 7, wherein said at least a part of said policy control includes an entirety of said policy control.

11. The network node according to claim 1, wherein said actions further are based on policies and subscribed services for a roaming subscriber of said user equipment.

12. The network node according to claim 1, wherein
said communications interface is further arranged to, from a gateway through which said user equipment is arranged to access Internet or from another network node executing said service, acquire data relating to at least one of:
a call detail record,
data volumes consumed by said user equipment, and
calls made from said user equipment; and
wherein said communications interface is further arranged to transmit said acquired data to said home network operator.

13. The network node according to claim 1, wherein
said communications interface is further arranged to, from said home network operator, receive a management request, said management request relating to management of specified functionality of said home network operator; and wherein
said processing unit is further arranged to, in response to the management request, manage said specified functionality of said home network operator.

14. The network node according to claim 1, wherein
said communications interface is further arranged to, with said home network operator, exchange data to confirm that said network node manages connections and services of said user equipment according to said service control and policy environment of said home network operator.

15. The network node according to claim 1, wherein
said processing unit is further arranged to perform control and management of access to content, said content including at least one of:
content directly accessible via said network node for the user equipment from a service,
content in tie memory of said network node,
content at the content storage of the borne network operator, and
content accessible via the point of interface, Pol, of the home network operator.

16. The network node according to claim 1, wherein
said processing unit is further arranged to execute a selected service including voice call handling of said user equipment.

17. The network node according to claim 1, wherein
said processing unit is further arranged to control and/or handle adult content filtering in said user equipment.

18. The network node according to claim 1, wherein
said processing unit is further arranged to perform deep packet inspection, DPS, and/or anti-virus protection on behalf of said home network.

19. A method performed by a network node for said network node to act as a virtual home network, comprising the steps of:
receiving, by a communications interface, a service request for a service from a user equipment in a visited network, the user equipment being associated with a home network operator and the service being associated with actions;
receiving, by said communications interface, a service control and policy environment of said home network operator said communications interface thereby acquiring control of said actions; and
determining, by a processing unit arranged, a service access route for said user equipment to access said service based on said actions.

20. One or more computer readable media comprising computer program code for causing a network node to act as a virtual home network, wherein the computer program code, when run on one or more processing units of said network node, causes the network node to:
receive a service request for a service from a user equipment in a visited network, the user equipment being associated with a home network operator and the service being associated with actions;
receive a service control and policy environment of said home network operator, thereby acquiring control of said actions; and to
determine, based on said actions, a service access route for said user equipment to access said service.
